(19) United States
(12) Patent Application Publication
(10) Pub. No.: US 2025/0118511 A1
(43) Pub. Date: Apr. 10, 2025

(54) TEMPERATURE-DEPENDENT SWITCHING MECHANISM AND TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 18/903,229

(22) Filed: Oct. 1, 2024

(30) Foreign Application Priority Data
Oct. 10, 2023 (DE) 10 2023 127 596.8

(51) Int. Cl. H01H 37/54

(52) U.S. Cl. CPC H01H 37/54; H01H 2037/5481

(57) ABSTRACT

A temperature-dependent switching mechanism for a temperature-dependent switch, having a bimetal element, a spring element, an electrically conductive contact part, and at least one retaining claw. The contact part is provided at the spring element or fixed to the spring element. The at least one retaining claw is provided at the spring element or fixed to the spring element. The at least one retaining claw comprises a support surface. The bimetal element is configured to snap from a low-temperature configuration to a high-temperature configuration upon exceeding a response temperature, wherein the bimetal element is supported on the support surface in its high-temperature configuration.

### CROSS-REFERENCE TO RELATED APPLICATIONS

This application claims priority from German patent application DE 10 2023 127 596.8 filed on Oct. 10, 2023. The entire contents of this priority application are incorporated herein by reference.

### FIELD

This disclosure relates to a temperature-dependent switching mechanism for a temperature-dependent switch. The disclosure further relates to a temperature-dependent switch having such a temperature-dependent switching mechanism.

Exemplary temperature-dependent switching mechanisms and switches are disclosed in DE 10 2011 119 632 B3, DE 10 2022 118 405 B3 and DE 10 2013 017 232 A1.

Such temperature-dependent switches are used in a principally known manner to monitor the temperature of a device. For this purpose, the switch is brought into thermal contact with the device to be protected, e.g. via one of its outer surfaces, so that the temperature of the device to be protected influences the temperature of the switching mechanism arranged inside the switch.

The switch is typically connected electrically in series into the supply circuit of the device to be protected via connecting cables, so that below the response temperature of the switch, the supply current of the device to be protected flows through the switch.

In the switch disclosed in DE 10 2011 119 632 B3, the switching mechanism is arranged inside a switch housing. The switch housing is formed in two parts. It comprises a lower part, which is firmly connected to a cover part with an insulating foil interposed between. The temperature-dependent switching mechanism arranged in the switch housing comprises a spring element, to which a movable contact part is fixed, and a bimetal element placed over the movable contact part. The spring element presses the movable contact part against a stationary counter contact arranged on the inside of the switch housing at the cover part. The outer edge of the spring element, configured as a snap-action spring disc, is supported in the lower part of the switch housing so that the electric current flows from the lower part through the snap-action spring disc and the movable contact part into the stationary counter contact and from there into the cover part.

The temperature-dependent bimetal element, which in the case of the switch disclosed in DE 10 2011 119 632 B3 is disc-shaped and is often referred to as a bimetal snap-action disc, is essentially responsible for the temperature-dependent switching behavior of the switching mechanism. This bimetal element is usually configured as a multi-layered, active, sheet-shaped device composed of two, three or four interconnected components with different thermal expansion coefficients. The connection of the individual metal or metal alloy layers in bimetal elements of this type is usually a material-locking or positive locking connection and is achieved, for example, by rolling.

Such a bimetal element has a first stable geometric configuration (low-temperature configuration) at low temperatures, below the response temperature of the bimetal element, and a second stable geometric configuration (high-temperature configuration) at high temperatures, above the response temperature of the bimetal element. The bimetal element snaps from its low-temperature configuration to its high-temperature configuration in a temperature-dependent manner in the manner of a hysteresis.

Thus, if the temperature of the bimetal element rises above the response temperature of the bimetal element as a result of a temperature increase in the device to be protected, the bimetal element snaps from its low-temperature configuration to its high-temperature configuration. Thereby, the bimetal element works against the spring element in such a way that it lifts the movable contact part from the stationary counter contact, so that the switch opens and the device to be protected is switched off and cannot heat up any further.

Unless a reset lock is provided, the bimetal element snaps back to its low-temperature configuration so that the switch is closed again as soon as the temperature of the bimetal element drops below the so-called reset temperature of the bimetal element as a result of cooling of the device to be protected.

In its low-temperature configuration, the bimetal element is preferably mounted in the switch housing in a mechanically force-free manner, wherein the bimetal element is also not used to carry the current. This has the advantage that the bimetal element has a longer service life and that the switching point, i.e. the response or switching temperature of the bimetal element, does not change even after many switching cycles.

In the case of a large number of temperature-dependent switches, the bimetal element is therefore preferably inserted into the switch housing as a loose individual part during the manufacture of the switch, wherein the bimetal element is placed over the contact part fixed to the spring element, for example, with a central through hole provided therein. Only by closing the switch housing, the bimetal element is fixed in its position and its position relative to the other components of the switch mechanism is defined. However, the production of such a switch, in which the bimetal element is inserted individually, has proven to be relatively cumbersome, as several steps are necessary to insert the switch into the switch housing. Such switches can therefore usually be automatically produced only with difficulty.

In the switch disclosed in DE 10 2011 119 632 B3, the bimetal element is therefore connected to the contact part fixed to the spring element in advance (outside the switch housing). For this purpose, the bimetal element is placed over the contact part and then an upper collar of the contact part is bent over. As a result, not only is the spring element fixed to the contact part, but the bimetal element is also held captive on the contact part.

The switching mechanism, consisting of the bimetal element, the spring element and the contact part, can thus be manufactured in advance as a semi-finished product, which forms a captive unit and can be stored separately as bulk material. When manufacturing the switch, the switching mechanism can then be inserted into the switch housing as a captive unit in just one work step. This simplifies the production of the switch many times over.

In the switch disclosed in DE 10 2011 119 632 B3, the spring element is welded or soldered to the contact part in order to achieve the best possible electrical contact between the two components. However, it has been shown that the welded or soldered connection between the contact part and the spring element can break, in particular when the switch is stored in bulk as a semi-finished product. Such defective switches can then, of course, no longer be inserted. In particular, it is problematic that such a defect can only be detected after the switch has been assembled, as only then is it possible to test the function of the switching mechanism.

In particular, the latter points have been improved in the switching mechanism disclosed in DE 10 2022 118 405 B3. The switching mechanism disclosed in this document comprises an additional switching mechanism housing in which the switching mechanism unit, which comprises the bimetal element, the spring element and the contact part, is held captive but with play. This additional switching mechanism housing not only enables the pre-production of the switching mechanism as a semi-finished product, but also protects the fragile components of the switching mechanism from damage, in particular during storage. This also simplifies the installation of the switching mechanism in a switch. Furthermore, the additional switch housing has the advantage that the switching mechanism can be functionally tested before it is installed in the switch, since the snap-action behavior of the bimetal element can already be tested in the switch housing.

A similarly advantageous solution is disclosed in DE 10 2013 017 232 A1. The temperature-dependent switching mechanism disclosed in this document comprises an annular frame in which the bimetal element and the spring element are held captive. This design also protects the fragile devices of the switching mechanism during storage. In addition, a functional test of the switching mechanism is possible even before it is installed in the switch or the switching mechanism housing.

Although particularly the latter two solutions have proven to be advantageous, there is still room for further improvements. In particular, the manufacturability of the switching mechanism can be improved and its size further reduced.

Furthermore, further simplifications and improvements should lead to additional cost savings.

### SUMMARY

It is an object to provide a temperature-dependent switching mechanism in which, in particular, the points mentioned above are further improved. In particular, it is an object to provide a temperature-dependent switching mechanism which can be pre-produced as a semi-finished product and stored as bulk material without thereby being susceptible to damage leading to a defect of the switching mechanism. The switching mechanism, which is pre-produced as a semi-finished product, should nevertheless be as easy as possible to use in a temperature-dependent switch and enable it to be manufactured with as few work steps as possible. It should also be possible to test the function of the switching mechanism before it is installed in the switch.

According to a first aspect, a temperature-dependent switching mechanism is presented, comprising:
a bimetal element;
a spring element;
an electrically conductive contact part provided at the spring element or fixed to the spring element; and
at least one retaining claw provided at the spring element or fixed to the spring element, wherein the at least one retaining claw comprises a support surface;
wherein the bimetal element is configured to snap from a low-temperature configuration to a high-temperature configuration upon exceeding a response temperature, and wherein the bimetal element is supported on the support surface in its high-temperature configuration.

The switching mechanism thus comprises one or more retaining claw(s) which is/are provide at or fixed to the spring element and which serve(s) to retain the bimetal element. The at least one retaining claw not only serves to retain the bimetal element in order to prevent it from detaching from the switching mechanism, but at the same time also to protect the bimetal element during a bulk storage of the switching mechanism.

The at least one retaining claw comprises a support surface, on which the bimetal element is supported in its high-temperature configuration. This has the advantage that a functional test can be performed with the switching mechanism even before it is installed in a switch. The bimetal element can assume both of its states/configurations (low-temperature configuration and high-temperature configuration) within the switching mechanism without the need for further components.

Compared to the prior art switching mechanisms mentioned at the beginning, the switching mechanism is significantly more compact and simpler, in particular composed of fewer components. Due to the provision of the at least one retaining claw, a switching mechanism housing, as proposed in DE 10 2022 118 405 B3, is no longer necessary. Since the at least one retaining claw is provided at the spring, for example is formed integrally with the spring element, or is fixed to the spring element, the switching mechanism is thus also significantly smaller or more compact than the switching mechanism disclosed in DE 10 2022 118 405 B3.

A ring-shaped frame, as proposed in DE 10 2013 017 232 A1, is also no longer necessary. Instead, the at least one retaining claw is used in the switching mechanism. Due to the support surface arranged thereon, the bimetal element can be supported directly on the retaining claw in its high-temperature configuration, which is also advantageous in contrast to the switching mechanism disclosed in DE 10 2013 017 232 A1, where the bimetal element is supported directly on the spring element in its high-temperature configuration This particularly relieves the spring element, which makes the switching mechanism more durable overall.

In a refinement, the bimetal element, the spring element and the contact part form a switching mechanism unit that is captively held together.

The individual parts of the switching mechanism unit can therefore no longer come loose from each other. On the one hand, this has the advantage that the switching mechanism can be pre-produced as a semi-finished product and can be stored more easily and reliably as bulk material or on a conveyor belt. In addition, the switching mechanism with all its individual parts can be inserted as a whole in a switch housing, which simplifies the assembly of the switch and thus makes it easier to automate.

In a further refinement, the bimetal element is held captive on the contact part and/or is held captive at the spring element by the at least one retaining claw.

This prevents loss of the bimetal element, in particular during storage on a belt or as bulk material. It also guarantees that the bimetal element will not detach from the switching mechanism when the switching mechanism is installed and used in a switch. The mechanically most stable and secure way of holding the bimetal element is achieved if it is both held captive at the contact part and held captive at the spring element by the at least one retaining claw.

In a further refinement, the at least one retaining claw projects unilaterally from a first side of the spring element facing the bimetal element.

In other words, the at least one retaining claw projects from the spring element on the same side on which the bimetal element is arranged. The advantage of the at least one retaining claw protruding on one side is that the embodiment of the switching mechanism is as space-saving as possible.

In the case of several retaining claws, these preferably all project from the same (first) side of the spring element on one side.

In a further refinement, the at least one retaining claw projects in a first direction from the first side of the spring element, wherein the support surface is oriented transversely to the first direction and faces the spring element.

In the present case, the term “transverse” does not necessarily mean an orthogonal or perpendicular orientation. Instead, it is understood to mean any type of orientation that is not parallel. Thus, an oblique orientation at an angle not equal to 0° also falls under the term “transverse”.

According to the aforementioned refinement, the at least one retaining claw preferably comprises a first section which projects from the spring element and extends in the first direction, and a second section which is connected to the first section, extends transversely thereto and on which the support surface is arranged such that it faces the spring element. Particularly preferably, the at least one retaining claw has the cross-sectional shape of an inverted (upside-down) L.

In a further refinement, the at least one retaining claw comprises at least two retaining claws.

According to this refinement, the at least two retaining claws are preferably arranged at a distance from one another on the spring element. Particularly preferably, the at least two retaining claws according to this refinement each have the same distance from a central axis of the spring element. In the case of three or more retaining claws, these are preferably arranged evenly distributed on the spring element, so that a rotational symmetry around the central axis results.

The embodiment of several, individual retaining claws is usually easier and more cost-effective to manufacture than a comparatively large, continuous retaining claw that extends, for example, along the entire circumference or along a majority of the circumference of the bimetal element (i.e. more than 50% of the circumference of the bimetal element).

In a further refinement, the at least one retaining claw is integrally connected to the spring element or is fixed to the spring element in a material-locking manner.

The at least one retaining claw can therefore, for example, be formed in one piece with the spring element. Alternatively, the at least one retaining claw is preferably welded or soldered to the spring element. This creates a mechanically very stable retaining claw that is inseparably connected to the spring element.

In a further refinement, the spring element comprises an outer edge, wherein the at least one retaining claw is spaced apart from the outer edge.

Preferably, the outer edge is a circumferential outer edge from which the at least one retaining claw is spaced. Particularly preferably, the at least one retaining claw has a smaller distance from a central axis of the spring element than the outer edge of the spring element. In other words, the at least one retaining claw is preferably offset radially inwards with respect to the outer edge of the spring element, which can, for example, be disc-shaped, in particular circular disc-shaped.

This has the advantage that the switch mechanism can be very easily fixed in the switch housing of the switch when mounting a switch, as the outer edge of the spring element can be clamped between two parts of the switch housing to fix the switching mechanism. This does not impair the function of the at least one retaining claw.

In a further refinement, the outer edge lies in one plane and a radially inner area of the spring element is curved.

This further simplifies the fixing of the switching mechanism within the switch housing. In addition, the curved inner area of the spring element enables sufficient freedom of movement of the spring element so that it can move together with the bimetal element during the switching operations.

In a further refinement, the spring element has a first configuration when the bimetal element is in its low-temperature configuration, wherein the spring element is brought into a second configuration by the bimetal element when the bimetal element snaps into its high-temperature configuration.

Preferably, the spring element is a snap-action spring disc which, like the bimetal element, has two different configurations or states. It is particularly preferred that the two configurations/states of the spring element are mechanically stable configurations/states. Unlike the two configurations of the bimetal element, however, the two configurations/states of the spring element are temperature-independent.

In a further refinement, the spring element together with the at least one retaining claw forms an open housing in which the bimetal element is arranged but is accessible from outside, wherein this open housing at least partially surrounds the bimetal element from a first side, a second side opposite the first side and a circumferential side extending between and transversely to the first and second sides.

As a result, the bimetal element is to a certain extent arranged encapsulated in the housing formed by the spring element and the at least one retaining claw. This provides good protection for the bimetal element, which is advantageous in particular when the switching mechanism is stored in bulk. This type of “housing” preferably surrounds the bimetal element at least partially from all sides, while the bimetal element is still accessible from the outside, which is of immense importance for the function of the switching mechanism.

In a further refinement, the open housing formed by the spring element together with the at least one retaining claw comprises an opening on the second side, the inner diameter of which is smaller than an outer diameter of the bimetal element measured parallel thereto.

This ensures in a simple way that the bimetal element cannot be released from the at least one retaining claw. The bimetal element is thus held captive at the spring element.

In a further refinement, the switching mechanism is rotationally symmetrical about a central axis.

This also simplifies the installation of the switching mechanism, as the switching mechanism can be inserted into the switch housing of the switch in any orientation relative to its central axis. In addition, the symmetrical orientation of the switching mechanism ensures an optimum force distribution when the switch is closed.

In a further refinement, the bimetal element comprises an opening through which the contact part protrudes. The bimetal element is preferably disc-shaped. The aforementioned opening is preferably inserted centrally in the bimetal element, wherein the bimetal element is placed over the contact part with this opening.

In a further refinement, the spring element preferably comprises an electrically conductive material.

This has the advantage that the spring element can be used as an electrically conductive component so that the current flows through the spring element when the switch is closed. The current does not have to flow through the bimetal element when the switch is closed, which reduces the load on the bimetal element and has a positive effect on its service life.

As already mentioned at the outset, the present disclosure relates not only to the temperature-dependent switching mechanism, but also to a temperature-dependent switch in which the presented switching mechanism is inserted.

According to a second aspect, a temperature-dependent switch having a temperature-dependent switching mechanism is presented, the temperature-dependent switching mechanism comprising:
a bimetal element;
a spring element;
an electrically conductive contact part provided at the spring element or fixed to the spring element; and
at least one retaining claw provided at the spring element or fixed to the spring element, wherein the at least one retaining claw comprises a support surface;
   wherein the bimetal element is configured to snap from a low-temperature configuration to a high-temperature configuration upon exceeding a response temperature, and wherein the bimetal element is supported on the support surface in its high-temperature configuration.

It is understood that the above-mentioned refinements and the features defined in the dependent claims relate not only to the switching mechanism, but in the same way also to the switch.

In a refinement of the temperature-dependent switch, it comprises a switch housing in which the temperature-dependent switching mechanism is arranged and which comprises a lower part and a cover part, wherein the spring element is clamped between the lower part and the cover part. Preferably, the outer edge of the spring element is clamped between the lower part and the cover part of the switch housing. The switch is therefore relatively easy to install and is mechanically stable.

It is to be understood that the features mentioned above and those to be explained below can be used not only in the combination indicated in each case, but also in other combinations or on their own, without departing from the spirit and scope of the present disclosure.

### BRIEF DESCRIPTION OF THE DRAWINGS

FIG. 1 shows a schematic sectional view of the temperature-dependent switching mechanism according to a first embodiment, wherein the switching mechanism is in a first switching state.

FIG. 2 shows a schematic sectional view of the temperature-dependent switching mechanism shown in FIG. 1, wherein the switching mechanism is in a second switching state.

FIG. 3 shows a schematic sectional view of the temperature-dependent switching mechanism according to a second embodiment, wherein the switching mechanism is in its first switching state.

FIG. 4 shows a schematic plan view of a spring element that can be used in the temperature-dependent switching mechanism.

FIG. 5 shows a schematic sectional view of the temperature-dependent switch according to an embodiment, wherein the switch is in its low-temperature state.

FIG. 6 shows a schematic sectional view of the temperature-dependent switch shown in FIG. 5, wherein the switch is in its high-temperature state.

FIG. 7 shows a schematic sectional view of the temperature-dependent switch according to a furthermore embodiment, wherein the switch is in its low-temperature state.

FIG. 8 shows a schematic sectional view of the temperature-dependent switch shown in FIG. 7, wherein the switch is in its high-temperature state.

### DESCRIPTION OF PREFERRED EMBODIMENTS

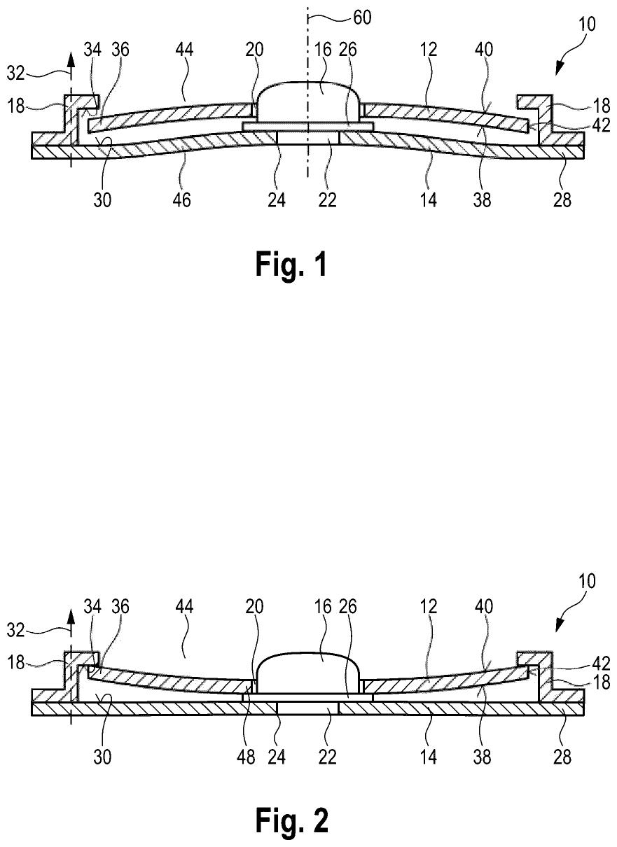

FIGS. 1 and 2 show a schematic sectional view of a first embodiment of the switching mechanism. FIG. 1 shows the low-temperature state of the switching mechanism. FIG. 2 shows the high-temperature state of the switching mechanism. In each case, the switching mechanism is denoted in its entirety with the reference numeral 10.

The switching mechanism 10 is a temperature-dependent switching mechanism. The switching mechanism 10 has a multi-part design. It comprises a bimetal element 12, a spring element 14, an electrically conductive contact part 16 and at least one retaining claw 18.

As the name suggests, the bimetal element 12 comprises a bimetal element. The spring element 14 and the contact part 16 are made of an electrically conductive material, preferably metal. The at least one retaining claw 18 is preferably also made of metal. However, the at least one retaining claw 18 does not necessarily have to be made of an electrically conductive material; it can also be made of an electrically non-conductive material.

In the embodiment shown in FIGS. 1 and 2, the bimetal element 12 is essentially circular disc-shaped. The bimetal element 12 is therefore also referred to as a bimetal disc. Due to its physical properties, the bimetal element 12 is sometimes also referred to as a bimetal snap-action disc.

In the shown embodiment, the bimetal element 12 comprises a central opening 20 with which the bimetal element 12 is placed over the contact part 16. In the embodiment shown in FIGS. 1 and 2, the bimetal element 12 is placed with its opening 20 over the contact part 16 without being firmly connected to the contact part 16. In other words, bimetal element 12 and contact part 16 are loosely coupled with each other at this point and movable relative to each other.

In the present embodiment, the contact part 16 is fixed to the spring element 14. More precisely, in this embodiment, the contact part 16 is connected to the spring element 14 in a material-locking manner. The contact part 16 is soldered or welded to the spring element 14, for example. For better centering, the contact part 16 comprises an extension 22 at its end, with which it is inserted into an opening 24 provided centrally in the spring element 14. Approximately in the middle, the contact part 16 comprises a collar 26, with the bottom side of which the contact part 16 lies flat on the top side of the spring element 14. The material-locking connection between the spring element 14 and the contact part 16 is preferably provided on the bottom side of the collar 26. The collar 26 provided on the contact part 16 also serves to support the bimetal element 12 in its high-temperature configuration (see FIG. 2), as will be explained in more detail in the following.

It should be noted at this point that the contact part 16 can also be integrally connected to the spring element 14 instead of being connected in a material-locking manner. In other words, the spring element 14 and the contact part 16 can be formed in one piece. In such a case, the contact part 16 is preferably formed as a raised portion that projects from the top side of the spring element 14.

The at least one retaining claw 18 is arranged in the area of the outer edge 28 of the spring element 14. In the embodiment shown in FIGS. 1 and 2, the at least one retaining claw is fixed to the spring element 14 in a material-locking manner, for example by welding or soldering.

The at least one retaining claw 18 unilaterally projects from the top side 30 of the spring element 14, which is also referred to as the first side 30 of the spring element 14 in the present case. This first side 30 of the spring element 14 is the side of the spring element 14 that faces the bimetal element 12.

More precisely, the at least one retaining claw 18 protrudes from the first side 30 of the spring element 14 in a first direction 32, which corresponds to the vertical direction in FIGS. 1 and 2. A support surface 34 is provided on the inside of the at least one retaining claw 18. This support surface 34 extends transversely, preferably perpendicular to the first direction 32. In its high-temperature state, the bimetal element 12 is supported with its outer edge 36 on this support surface 34, as will be explained in more detail in the following (see FIG. 2).

Together with the at least one retaining claw 18, the spring element forms a partially open housing, so to speak, in which the bimetal element 12 is arranged and held captive, but is accessible from the outside. This open housing formed by the spring element 14 and the at least one retaining claw 18 surrounds a first side 38 of the bimetal element 12, which faces the first side 30 of the spring element 14, as well as an opposite second side 40 of the bimetal element 12, and a bimetal element peripheral side 42 extending transversely to the first and second bimetal element sides 38, 40, in each case at least partially. The open housing formed by the spring element 14 together with the at least one retaining claw 18 comprises an opening 44 on a side facing the second side 40 of the bimetal element 12, through which the movable contact part 16 is accessible to the outside.

The inner diameter of this opening 44 is smaller than an outer diameter of the bimetal element 12 measured parallel to it. This ensures that the bimetal element 12 is held captive on the spring element 14 by the at least one retaining claw 18. The bimetal element 12, the spring element 14 and the contact part 16 thus form a captively held together switching mechanism unit.

In the low-temperature state of the switching mechanism 10 shown in FIG. 1, the bimetal element 12 is convexly curved on its second side 40 (top side of the bimetal element 12). Similarly, a radially inner area 46 of the spring element 14 is convexly curved on its first side 30 (top side of the spring element 14) in the low-temperature state shown in FIG. 1. In other words, in the low-temperature state of the switching mechanism 10, both the bimetal element 12 and the radially inner area 46 of the spring element 14 are curved upwardly (see FIG. 1). In this shift position, the bimetal element 12 lies loosely on the collar 26 of the contact part 16 from above. The free outer edge 36 of the bimetal element 12 is born approximately force-free and preferably has no contact with the spring element 14 and/or the at least one retaining claw 18.

If, starting from this switching state of the switching mechanism 10, the temperature of the switching mechanism 10 now rises above a response temperature of the bimetal element 12, the bimetal element 12 snaps from its low-temperature state shown in FIG. 1 into its high-temperature state shown in FIG. 2. The second side 40 of the bimetal element 12 (top side of the bimetal element 12) is now concavely curved. Thereby, the bimetal element 12 is supported with its outer edge 36 on the support surface 34, which is arranged on the at least one retaining claw 18. At the same time, the bimetal element 12 presses the contact part 16 in the direction of the spring element 14 with its inner edge 48. In other words, both the bimetal element 12 and the spring element 14 curve downwards, so that not only the bimetal element 12 is now concavely curved on its second side 40 (top side), but also the spring element 14 is now concavely curved on its first side 30 (top side).

Since the at least one retaining claw 18 acts as a kind of abutment in the high-temperature state of the switching mechanism 10, on which the bimetal element 12 can be supported, and the switching mechanism 10 together with its devices 12, 14, 16, 18 also forms a captively held together switching mechanism unit in the low-temperature state, a functional check of the switching mechanism 10 can also be performed without further devices, and in particular without the need to install the switching mechanism 10 in a temperature-dependent switch. The switching mechanism 10 shown in FIGS. 1 and 2 thus forms a separately functional, storable semi-finished product.

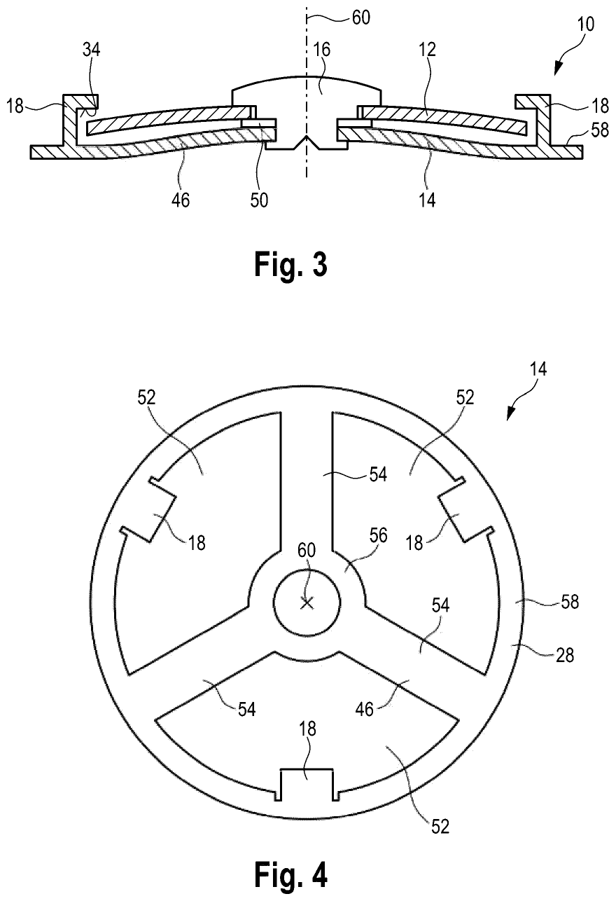

FIG. 3 shows a second embodiment of the switching mechanism 10 in a schematic sectional view. The basic structure and the mode of operation of the switching mechanism 10 do not differ from the first embodiment shown in FIGS. 1 and 2. The basic design of the switching mechanism 10 is also at least similar to that of the first embodiment. One difference, however, is that the at least one retaining claw 18 is integrally connected to the spring element 14 or is formed integrally with it. Preferably, the spring element 14 and the at least one retaining claw 18 are formed from a thin sheet metal.

A further difference of this second embodiment shown in FIG. 3 is that the contact part 16 is designed here as a kind of rivet, which is connected to both the bimetal element 12 and the spring element 14. In the second embodiment shown in FIG. 3, the bimetal element is thus not only held captive at the spring element by the at least one retaining claw 18, but is also held captive at the contact part 16. A support ring 50 can be arranged between the bimetal element 12 and the spring element 14 on the contact part 16, which is designed as a rivet. However, the latter is not absolutely necessary.

FIG. 4 shows the spring element 14 of the embodiment of the switching mechanism 10 shown in FIG. 3 in a top view from above. As can be seen from this, the spring element 14 is essentially circular disc-shaped, wherein various recesses 52 are provided in order to reduce the electrical resistance and save material. Instead of a (single) retaining claw 18 running completely around the circumference, three retaining claws 18 are provided here, which are distributed and arranged at a distance from one another. More precisely, the three retaining claws are regularly distributed around the circumference of the spring element 14. It is understood that, in principle, two or more than three retaining claws 18 can also be provided. Similarly, only a single retaining claw 18 can also serve as an abutment for the bimetal element 12, provided that this at least one retaining claw 18 extends over a larger part of the circumference of the spring element 14.

The at least one retaining claw 18 is preferably arranged at a distance from the outer edge 28 of the spring element 14. Adjacent to this outer edge 28, the spring element 14 preferably comprises a peripheral edge region 58 which lies in one plane, i.e. is flat or planar. The radially inner area 46 of the spring element 14, which in the embodiment shown in FIG. 4 is formed by three radially extending webs 54 and a central area 56, is curved.

The flat or flat outer edge area 58 of the spring element 14 offers the advantage of the simplest possible attachment and fixing within a temperature-dependent switch, as will be explained in more detail in the following.

The spring element 14 is rotationally symmetrical around a central axis 60. Similarly, the entire switching mechanism 10 is also preferably rotationally symmetrical about the central axis 60. Accordingly, the switching mechanism 10 can be inserted into a switch housing of a switch in any position rotated about the central axis 60. This simplifies the assembly of the switching mechanism 10 many times over.

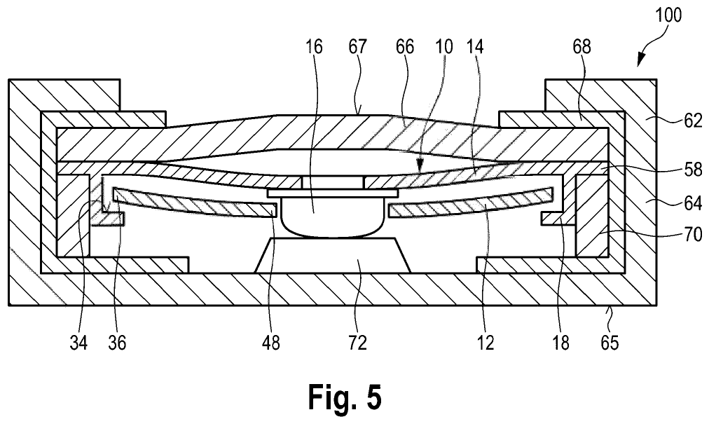

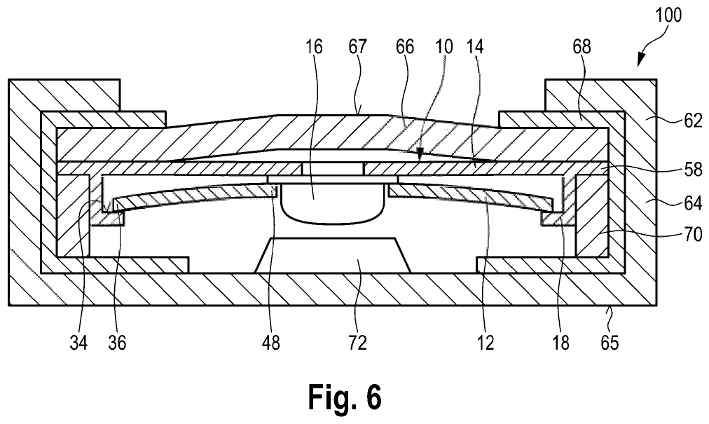

FIGS. 5 and 6 show a first embodiment of a temperature-dependent switch in which the switching mechanism 10 is used. FIG. 5 shows the low-temperature state of the switch. FIG. 6 shows the high-temperature state of the switch. In each case, the switch is designated in its entirety with the reference numeral 100. The switch 100 comprises a switch housing 62, which functions as a housing for the switching mechanism 10. The switch housing 62 comprises a pot-like lower part 64 and a cover part 66, which is held on the lower part 64 by a bent or flanged upper edge of the lower part 64.

In the embodiment shown in FIGS. 5 and 6, both the lower part 64 and the cover part 66 are made of an electrically conductive material, preferably metal. An insulating foil 68 is arranged between the lower part 64 and the cover part 66. The insulating foil 68 provides electrical insulation of the lower part 64 from the cover part 66. The insulating foil 68 also provides a mechanical seal that prevents liquids or impurities from entering the interior of the housing from the outside.

Since the lower part 64 and the cover part 66 are each made of electrically conductive material, thermal contact to an electrical apparatus to be protected can be established via their outer surfaces. The outer surfaces can also be used for the electrical connection of the switch 100. For example, the outer surface 65 of the lower part 64 can function as the first electrical terminal and the outer surface 67 of the cover part 66 can function as the second electrical terminal of the switch 100.

The switching mechanism 10 is arranged clamped between the lower part 64 and the cover part 66. More precisely, the switching mechanism 10 is arranged clamped between a spacer ring 70 and the cover part 66. For this purpose, the outer edge region 58 of the spring element 14 rests on the spacer ring 70 and is clamped from the opposite side by the cover part 66.

Furthermore, the switching mechanism 10 rests with its at least one retaining claw 18 against the inner circumference of the spacer ring 70. With the help of the spacer ring 70, it is therefore possible to both fix and center the switching mechanism 10. As a result, the movable contact part 16 of the switch mechanism 10 is oriented relative to a stationary counter contact 72 arranged on the inside of the lower part 64 of the switch housing 62. This counter-contact 72 is also referred to as a stationary contact in the present case.

In the low-temperature state of the switch 100 shown in FIG. 5, which is also referred to as the closed state of the switch 100, the switching mechanism 10 establishes an electrically conductive connection between the lower part 64 and the cover part 66 and thus between the two external connection surfaces 65, 67 of the switch 100. The electrically conductive contact between the two external connection surfaces 65, 67 of the switch 100 is established in particular via the spring element 14 and the movable contact part 16, which interacts with the stationary contact 72. The contact pressure between the movable contact part 16 and the stationary contact 72 is generated by the spring element 14. In this state, the bimetal element 12 is stored in the switching mechanism 10 in a more or less force-free manner.

If the temperature of the device to be protected and thus the temperature of the switch 100 now increases to the switching temperature of the bimetal element 12 or above the switching temperature, the bimetal element 12 snaps from its low-temperature state shown in FIG. 5 to its high-temperature state shown in FIG. 6. During this snap-action, the bimetal element 12 is supported with its outer edge 36 on the support surface 34, which is provided on the at least one retaining claw 18, and presses the movable contact part 16 upwardly with its inner edge 48 together with the spring element 14. As a result, the spring element 14 simultaneously bends upwardly with its center, whereby the movable contact part 16 is lifted off the stationary contact 72. The circuit is thus interrupted and the switch 100 is thus opened.

If the device to be protected and thus the switch 100 together with the bimetal element 12 then cool down again, the bimetal element 12 snaps back to its low-temperature state when a reset temperature is reached, which is also referred to as the switch-back temperature, as shown in FIG. 5, for example. This allows a reversible switching behavior to be realized.

Of course, it is also possible for the switch 100 to be prevented from switching back after it has snapped to the high-temperature state by a corresponding locking device. A large number of such locking devices, which are used in particular for one-time switches in which switching back is to be prevented, are already known from the prior art.

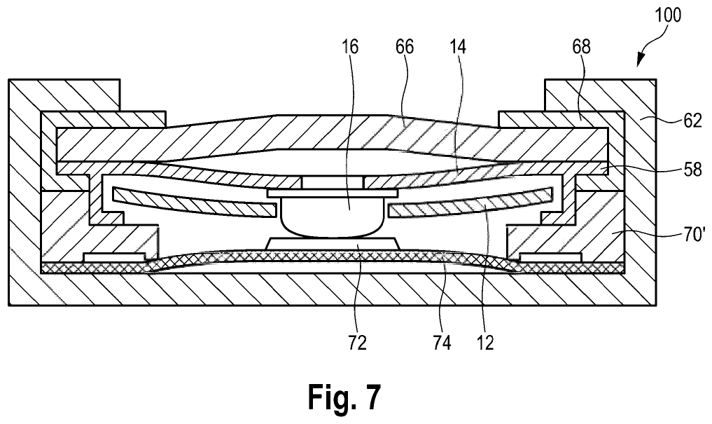

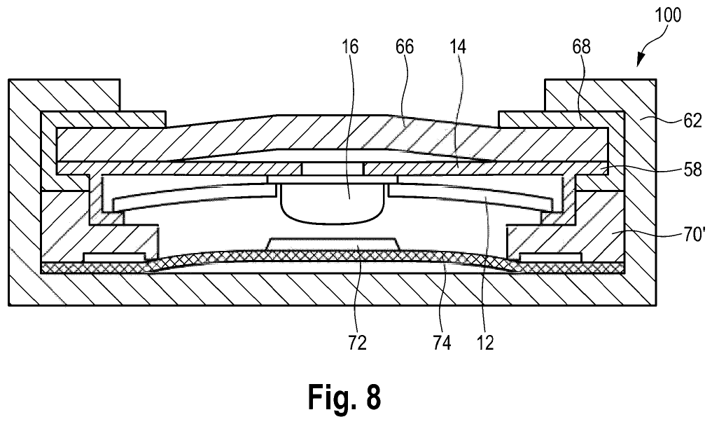

FIGS. 7 and 8 show a further embodiment of the switch 100, again in a schematic sectional view both in the low-temperature state (FIG. 7) and in the high-temperature state (FIG. 8) of the switch 100.

The spacer ring 70′ is shaped slightly differently here. However, a significant difference to the embodiment shown in FIGS. 5 and 6 is that the counter-contact 72 is not designed here as a stationary contact, but is arranged on a counter-spring element 74. This counter-spring element 74 allows manufacturing tolerances to be optimally compensated for. On the other hand, the contact pressure can be increased in the closed state of the switch (see FIG. 7), as the counter-spring element 74 counteracts the spring element 14 and thus increases the force with which the two contacts 16, 72 are pressed together. However, the switching principle otherwise remains the same as previously described with reference to the embodiment shown in FIGS. 5 and 6.

It is understood that various further modifications can be made both to the switch mechanism 10 itself and to the switch housing 62 without departing from the spirit and scope of the present disclosure. Furthermore, the shape of the at least one retaining claw shown in the present case can be varied almost at will, which is why the term “retaining claw” is to be interpreted broadly in the present case. Functionally, the at least one retaining claw 18 serves as a holder for the bimetal element 12, against which the latter can be supported with its edge 36, in particular in the high-temperature state of the switching mechanism 10.

Furthermore, it is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A temperature-dependent switching mechanism for a temperature-dependent switch, comprising:
a bimetal element;
a spring element;
an electrically conductive contact part provided at the spring element or fixed to the spring element; and
at least one retaining claw provided at the spring element or fixed to the spring element, wherein the at least one retaining claw comprises a support surface;
wherein the bimetal element is configured to snap from a low-temperature configuration to a high-temperature configuration upon exceeding a response temperature, and wherein the bimetal element is supported on the support surface in its high-temperature configuration.

2. The temperature-dependent switching mechanism according to claim 1, wherein the bimetal element, the spring element and the contact part form a switching mechanism unit that is captively held together.

3. The temperature-dependent switching mechanism according to claim 1, wherein the bimetal element is held captive at the contact part.

4. The temperature-dependent switching mechanism according to claim 1, wherein the bimetal element is held captive by the at least one retaining claw.

5. The temperature-dependent switching mechanism according to claim 1, wherein the at least one retaining claw projects from a first side of the spring element facing the bimetal element.

6. The temperature-dependent switching mechanism according to claim 5, wherein the at least one retaining claw projects in a first direction from the first side of the spring element, and wherein the supporting surface is oriented transversely to the first direction and faces the spring element.

7. The temperature-dependent switching mechanism according to claim 1, wherein the at least one retaining claw comprises at least two retaining claws.

8. The temperature-dependent switching mechanism according to claim 7, wherein the at least two retaining claws are spaced apart from each other along a circumference of the spring element.

9. The temperature-dependent switching mechanism according to claim 1, wherein the at least one retaining claw comprises a single retaining claw that extends along a majority of a circumference of the spring element or along the entire circumference of the spring element.

10. The temperature-dependent switching mechanism according to claim 1, wherein the at least one retaining claw is integrally connected to the spring element.

11. The temperature-dependent switching mechanism according to claim 1, wherein the at least one retaining claw is fixed to the spring element.

12. The temperature-dependent switching mechanism according to claim 1, wherein the spring element comprises a radially outer edge and the at least one retaining claw is spaced apart from the radially outer edge.

13. The temperature-dependent switching mechanism according to claim 12, wherein the radially outer edge lies in one plane and a radially inner area of the spring element is curved.

14. The temperature-dependent switching mechanism according to claim 1, wherein the spring element together with the at least one retaining claw forms an open housing in which the bimetal element is arranged, but is accessible from outside, wherein this open housing at least partially surrounds the bimetal element from a first side, a second side opposite the first side and a circumferential side extending between and transversely to the first and second sides.

15. The temperature-dependent switching mechanism according to claim 14, wherein the open housing comprises an opening on the second side, an inner diameter of which is smaller than an outer diameter of the bimetal element measured parallel thereto.

16. The temperature-dependent switching mechanism according to claim 1, wherein the switching mechanism is rotationally symmetrical about a central axis, and wherein the bimetal element comprises a central opening through which the contact part projects.

17. A temperature-dependent switch having a temperature-dependent switching mechanism, the temperature-dependent switching mechanism comprising:
a bimetal element;
a spring element;
an electrically conductive contact part provided at the spring element or fixed to the spring element; and
at least one retaining claw provided at the spring element or fixed to the spring element, wherein the at least one retaining claw comprises a support surface;
wherein the bimetal element is configured to snap from a low-temperature configuration to a high-temperature configuration upon exceeding a response temperature, and wherein the bimetal element is supported on the support surface in its high-temperature configuration.

18. The temperature-dependent switch according to claim 17, wherein the switch comprises a switch housing in which the temperature-dependent switching mechanism is arranged, the switch housing comprising a lower part and a cover part, wherein the spring element is clamped between the lower part and the cover part.
